(19) United States
(12) Patent Application Publication
(10) Pub. No.: US 2001/0054695 A1
(43) Pub. Date: Dec. 27, 2001

(54) Method and device for multiple viewpoint acquisition of images

(76) Inventors: Jean Lienard, Clamart (FR); Regis Vaillant, Villebon sur Yvette (FR); Laurent Breham, Chartrainville (FR); Francisco Sureda, Chatenay Malabry (FR)

Correspondence Address: Jay L. Chaskin, General Electric Company, 3135 Easton Turnpike - W3C, Fairfield, CT, 06431, US

(21) Appl. No.: 09/874,694

(22) Filed: Jun. 5, 2001

(30) Foreign Application Priority Data
Jun. 5, 2000 (FR) 0007155

(51) Int. Cl. G01T 1/20

(52) U.S. Cl. 250/368

(57) ABSTRACT

Method of acquisition of images of an object in an imaging system equipped with a rotating assembly comprising an energy beam emitter and an energy beam receiver, the energy beam being centered on an axis, in which a continuous path of the moving assembly is defined along at least two axes of a three-dimensional reference, the axis of the energy beam describing a left curve on the path; and, in the course of the path, the energy beam is emitted and images are acquired.

### CROSS REFERENCE TO RELATED APPLICATIONS

This application claims the benefit of a priority under 35 USC 119 to French Patent Application No. 0007155 filed Jun. 5, 2000, the entire contents of which are incorporated by reference.

### BACKGROUND OF THE INVENTION

The present invention is directed to the field of image acquisition and, in particular, to images obtained by means of a radiology apparatus. The invention may apply, particularly, to X-ray imaging devices, for example, in the medical field, particularly but not exclusively in cardiology.

A radiology apparatus used, for example, in mammography, RAD or RF conventional radiology and neurological or even vascular (peripheral or cardiac) radiology is generally composed: an X-ray tube and a collimator for forming and delimiting an X-ray beam; an image receiver, generally a radiological image intensifier and a video camera, or even a solid-state detector; a positioner carrying the X-ray tube and collimator assembly on one side and image receiver on the other, movable or rotatable in space about one or more axes; and a means of positioning the patient, object, e.g., such as a table provided with a platform designed to support the object in, for example, a supine position. A radiology apparatus further comprises means of control of the X-ray tube making it possible to adjust parameters such as the X-radiation dose, exposure time, high feed voltage, etc., from a means of control of the various motors enabling the radiology apparatus to be displaced on its different axes, as well as the means of positioning the patient and image processing means making possible a display on screen and data storage for two- or three-dimensional images with functions such as a zoom, a translation along one or more perpendicular axes, a rotation on different axes, a subtraction of images or also an extraction of the contour. Those functions are secured by electronic boards subject to different adjustments.

A method and device for acquisition of images of a body by placement in rotation is known from patent FR-A-2,705,224. In particular, FR-A-2,705,224 indicates that, by reason of the conicity of the X-ray beam, the measurements taken to quantify a lesion observed on an image, for example, on an angiographic examination, are correct only if the local direction of the vessel considered is parallel to the plane of the detector, and the quality of visualization and quantification of the lesions strongly depend on the choice of angles of incidence of acquisition.

The possibility of positioning the plane of the detector of the apparatus parallel to the main axis of a vessel enables the vessel to be visualized under the best conditions. FR-A-2,705,224 proposes using two reference images, acquired at two different angles of incidence, in order to determine automatically the three-dimensional orientation of the vessel of interest. With a three-axis apparatus, the angular positions of the first two axes are determined in order to place the third axis parallel to the vessel. Rotation on that third axis is then freely used to make the acquisitions.

In cardiac radiology, the user takes two-dimensional images for the purpose of obtaining three-dimensional images by reconstruction. The two-dimensional images are taken by fixing the angular positions of the first two axes and making a rotation in relation to the third axis. In order to obtain two-dimensional images as such, users makes the adjustments of angular positions themselves, which is relatively slow. For each image taken in a particular angular position, an injection of contrast medium is made.

### BRIEF DESCRIPTION OF THE INVENTION

An embodiment of the invention proposes a method of image acquisition which reduces the injection of contrast medium.

An embodiment of the invention proposes a more rapid method of image acquisition.

An embodiment of the invention proposes a method of acquisition of two-dimensional images with a view to a high-quality three-dimensional reconstruction.

The method, according to one aspect of the invention, is designed for the acquisition of images of an object in an imaging system equipped with a rotating assembly comprising an energy beam emitter and an energy beam receiver, the energy beam being centered on an axis. A continuous path or trajectory of the rotating assembly is defined along at least two axes of a three-dimensional coordinate system. The axis of the energy beam describes a left or three-dimensional curve on the path. In the course of the path, the energy beam is emitted and images are acquired.

The invention also concerns a device for acquisition of images, for example, X-ray images. The device comprises an energy beam emitter, an energy beam receiver, the energy beam being centered on an axis, and an arithmetical unit capable of controlling the emitter and of processing data coming from the receiver. The arithmetical unit comprises a means for defining a path or trajectory of the rotating assembly along at least two axes of a three-dimensional reference, the axis of the energy beam describing a left or three-dimensional during the curve path and a means for controlling the emission of the energy beam and the acquisition of images on the path.

The invention also concerns a computer program comprising program code means for using image acquisition stages, when the program is operating on a computer.

The invention also concerns a support capable of being read by a device reading program code means which are stored there and are suitable for use of image acquisition stages, when the program is operating on a computer.

### BRIEF DESCRIPTION OF THE DRAWINGS

An aspect of the invention is illustrated by the following figures:

FIG. 1 is a view in perspective of a three-axis radiology apparatus which can be used to apply the method;

FIG. 2 is a schematic view in perspective of a human heart;

FIG. 3 is a schematic view of three angulations;

FIG. 4 is a schematic view of a plane path; and

FIG. 5 is a schematic view of a path according to one aspect of the invention.

### DETAILED DESCRIPTION OF THE INVENTION

In an embodiment of the invention the path passes advantageously through or in immediate or close proximity to at least one reference position.

In an embodiment of the invention, the path passes through or in immediate or close proximity to a plurality of reference positions.

The energy beam is emitted in the course of the path, so that images are taken at chosen times or places. In the case of an image acquisition apparatus of multi-axis type, a place is defined by angles relative to a three-dimensional coordinate system, the axes of which can correspond to the mechanical axes of rotation of the apparatus or be defined in relation to a patient (craniocaudal axis, right-left axis, etc.). Such a path can be covered in approximately four to five seconds, making it possible to use a single injection of contrast medium.

The invention can be usefully applied in radiology, particularly in cardiac radiology. In the latter case, left-right and cranial-caudal rotations can be made to observe precisely the numerous coronary structures. To obtain two-dimensional images at varied angulations along at least two axes, the number of contrast medium injections is reduced to one. The different two-dimensional images will be taken in the course of displacement of the positioner while the positioner is moved. The total duration of imaging is therefore shortened. To reconstruct a three-dimensional image, favorable angulations will be taken advantage of for better image quality than in case the two-dimensional images intended for reconstruction are taken in rotation on a single axis.

The rate of displacement of the moving assembly is advantageously linked to its position in the three-dimensional coordinate system. The displacement can be rapid for narrow angulations and slow in proximity to wide angulations.

In an embodiment of the invention, the object to be imaged is a heart and images of a patient's heart are acquired.

The rate of displacement of the moving assembly is slow during systole and rapid during diastole.

In an embodiment of the invention, the rate of displacement of the rotating assembly is slow in proximity to reference positions and rapid between two reference positions.

The rate of displacement of the rotating assembly is preferably slow during systole in proximity to reference positions and rapid during diastole between two reference positions.

The rate of image acquisition is advantageously linked to the position of the rotating assembly in the three-dimensional coordinate system.

In an embodiment of the invention, the rate of acquisition of images is slow in proximity to reference positions and rapid between two reference positions.

In an embodiment of the invention, the reference positions are stored in a memory.

In an embodiment of the invention, the path is stored in a memory.

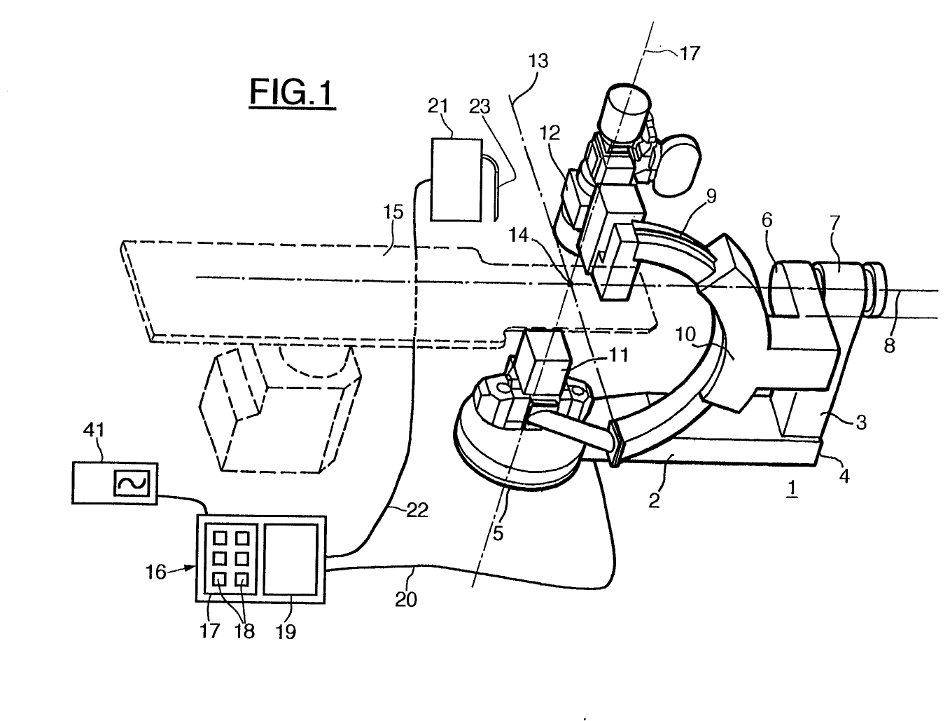

As can be seen in FIG. 1, the radiology apparatus comprises an L-shaped stand 1 with a roughly horizontal base 2 and a roughly vertical support 3 attached to one end 4 of the base 2. At the opposite end 5, the base 2 embraces an axis of rotation parallel to the support 3 and on which the stand is capable of rotating. A support arm 6 is attached by a first end to the top 7 of the support 3, rotating on an axis 8. The support arm 6 can have the shape of a bayonet. A C-shaped circular arm 9 is held by another end 10 of the support arm 6. The C-shaped arm 9 is capable of sliding rotationally about an axis 13 relative to the end 10 of the support arm 6.

The C-shaped arm 9 supports an X-ray emission means 11 and an X-ray detector 12 in diametrically opposite positions facing each other. The detector 12 has a plane detection surface. The direction of the X-ray beam is determined by a straight line joining a focal point of the emission means 11 to the center of the plane surface of the detector 12. The axis of rotation of the stand 1, the axis 8 of the support arm 6 and the axis 13 of the C-shaped arm 9 are secant at a point 14 called isocenter. In mid-position, those axes are perpendicular to one another. The axes of the X-ray beam also passes through point 14.

A table 15, provided to accommodate an object, such as a patient, possesses a longitudinal orientation aligned with the axis 8 in rest position.

The radiology apparatus further comprises a control unit 16 joined by wire connection 20 to the positioner formed by elements 1 to 10, to the Xray emission means 11 and to the detector 12. The control unit 16 includes processing means, such as a processor and one or more memories, connected to the processor by a communication bus, not represented. The control unit 16 further includes a control panel 17 provided with buttons 18 and possibly a control lever not represented, and by a screen 19 for image display which may be of the touch-sensitive type.

The radiology apparatus can be combined with a contrast medium injection device 21, to which it is joined by wire connection 22. The contrast medium injection device 21 is equipped with a needle 23 and is capable of injecting such product, which is iodine-base, for example, into a patient's blood vessel to allow visualization of the vessels situated below in the direction of blood flow, by rendering the blood more opaque to X-rays than it is naturally.

The control unit 16 makes it possible to calculate a path or trajectory and/or to store the path or trajectory in a memory. The path can be calculated from angulations, whether indicated by the user on the control panel 17 or by positioning the moving or rotatable assembly of the radiology apparatus according to that angulation and storing it in a memory. For example, by defining an angulation by three angles along three axes of a three-dimensional coordinate system, whether linked to the radiology apparatus or linked to the patient, the user can, for example, define a first angulation of coordinates (0,0,0), a second angulation of coordinates (0,0,α) and a third angulation of coordinates (0,β,0), with α and β not null/zero. The control unit 16 then determines a path or trajectory to be covered by the moving or rotatable parts of the radiology apparatus in order to pass through three angulations, while taking into account characteristics of the apparatus such as possible prohibited angulations, with the risk of causing a collision between the table 15 or the patient and the X-ray emission means 11 or the detector 12, mechanical or electromechanical characteristics of the radiology apparatus, such as maximum angular acceleration along a given axis and the passage time, which should be as short as possible, so that a single contrast medium injection can suffice for taking the desired images. For this purpose, the control unit 16 sends a synchronization signal to the injection device 21 in order to trigger the injection of contrast medium at a given time, for example, a few seconds before taking the first image. The probability is thus increased that a single injection of contrast medium will suffice and that the blood will remain opaque enough on taking the last image in the course of the same path.

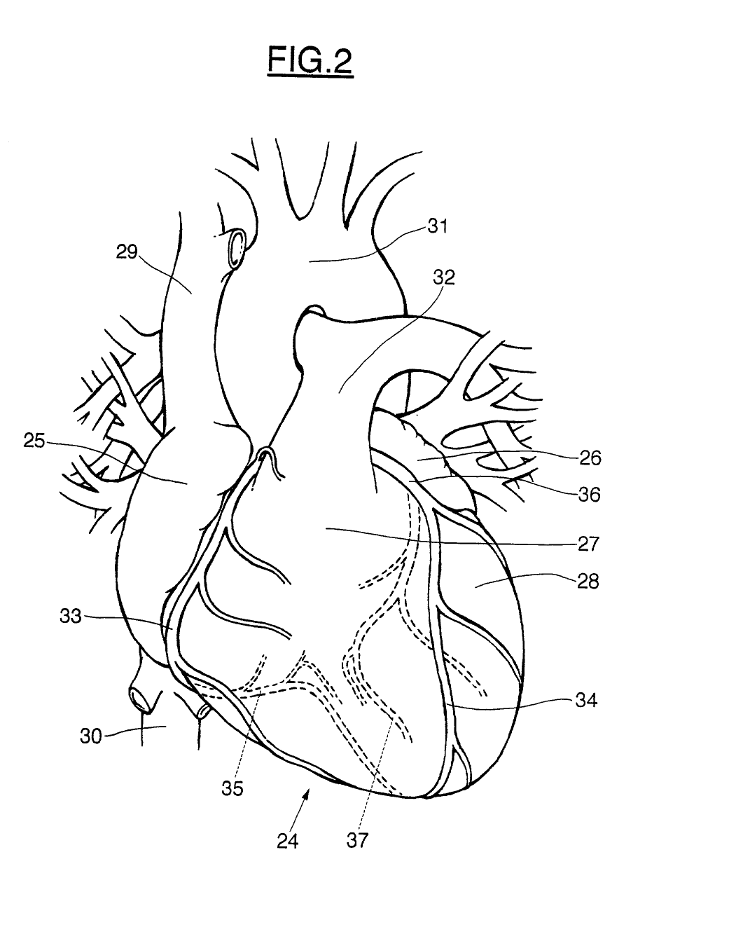

For a better understanding, a human heart 24 is represented in FIG. 2. The right auricle 25, the left auricle 26, the right ventricle 27, the left ventricle 28, the superior vena cava 29, the inferior vena cava 30, the aorta 31, the pulmonary artery 32, the right coronary or anterior lateral artery 33, the anterior interventricular artery 34, the posterior interventricular artery 35, the left main coronary artery 36 and the circumflex left artery 37 are shown. It is understood that a good visualization of the coronary arteries of the heart 24 requires varied angulations along several axes.

In other words, the curve defined by the axis of the X-ray beam on the path or trajectory of the rotating elements of the radiology apparatus is a left or three-dimensional curve. The need to have varied angulations along several axes is due to the fact that the heart can be likened to a three-dimensional object, the envelope of which is a closed surface. If a point inside the heart is chosen, its envelope occupies a solid angle equal to 4 π. The elements of interest are found all around that closed surface. The observation of the elements of interest ideally requires an angular movement over 360° along one axis and over 360° along another axis, those two axes being secant.

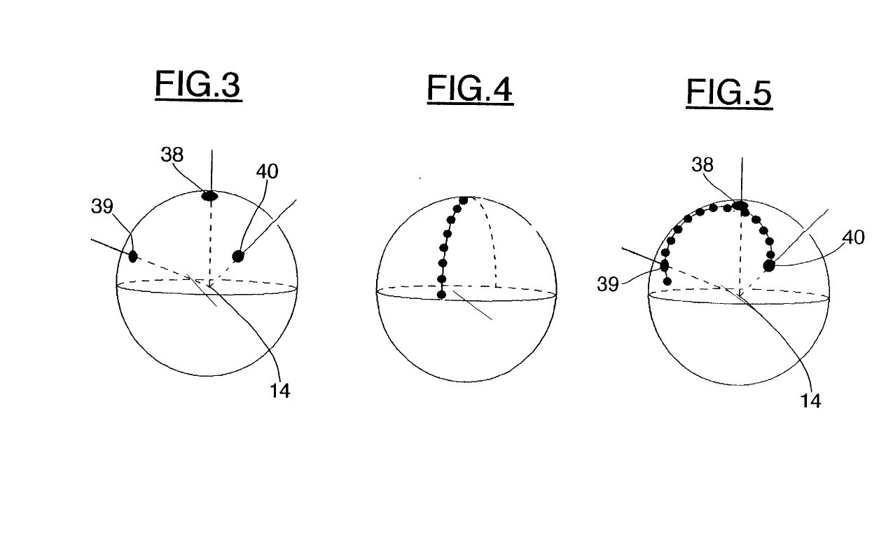

In FIG. 3, the various movements of the axis of the X-ray beam are illustrated by a sphere. The center of the sphere is the isocenter 14. Its radius is not important, considering that one is dealing with the angles. For a better understanding, the radius of that sphere can be considered equal to the distance between the isocenter 14 and the focus of the X-ray tube. Point 38 corresponds to a so-called “frontal” angulation, that is, the axis of the X-ray beam is vertical with the X-ray emission means situated below, and the receiver above, the patient. Point 39 corresponds to a so-called “60° left anterior oblique” angulation. Point 40 corresponds to a so-called “30° right anterior oblique/15° anterior caudal” angulation.

A coronary arteriography examination is commonly carried out by means of angiographic image acquisition at several predetermined and fixed angulations called reference positions. For each imaging, a contrast medium is injected into the vessel or above the vessel it is desired to examine. An X-ray emission is then made to obtain an image of the vessels. Several images can be taken at the same angulation to see the movements of the heart. From one reference position to another reference position, the position is motor-driven on manual command.

For example, for a good visualization of the left coronary artery, a reference position in 30° right anterior oblique view is adapted to analyze the circumflex branch and a part of the left anterior descending artery. Another reference position in angulation of slightly caudal type, that is, with the X-ray detection means 12 brought close to the patient's feet on examination, while maintaining the 30° angle previously described, can be used to see another part of the left anterior descending artery and to prevent it from being covered on the image by the circumflex branch of the intermediate vessels. Conversely, a reference position in angulation of cranial type on right anterior oblique projection makes possible a good visualization of the large septal of the diagonal vessels.

The reference position in 60° left anterior oblique angulation is used for study of the diagonal arteries and of a part of the left anterior descending artery. With a 20° cranial angulation, the 60° left anterior oblique angulation is applied to prevent the shortening of a part of the left anterior descending artery and supplies good images of the left main trunk and of the diagonal vessels. In side view, that is, with the axis of the X-ray beam horizontal, and in particular in left side view, another part of the left anterior descending artery and the different parts of the first diagonal artery and left edge marginal artery can be optimally seen.

For the right coronary artery, a reference position in angulation of 45° left anterior oblique type may be used associated with a 15° caudal angle. The reference position in 90° left anterior oblique angulation with 15° caudal deflection is employed for analysis of the vertical part of the right coronary artery and collateral branches, right ventricular artery and right edge marginal artery. The reference position in 45° right anterior oblique angulation with 15° caudal deflection is generally used for visualization of the superior interventricular artery and collateral branches, right ventricular artery, and right edge marginal artery.

In FIG. 4, the movement of the positioner in the radiology apparatus is also illustrated in the form of a sphere for a three-dimensional reconstruction from two-dimensional images. An acquisition is made in rotation during injection of the contrast medium into the vessels it is desired to examine. The path of the positioner is circular in a plane perpendicular to the main axis of the patient.

In FIG. 5, an example of a positioner path or trajectory according to an embodiment of the invention is illustrated. In general, an acquisition in rotation is made with the axis of the X-ray beam describing a non-plane surface. In the case illustrated, the rotary movement makes it possible to pass through points 38, 39 and 40, defined with reference to FIG. 3 and used in conventional radiology as reference positions. The path is optimized in order to require only one injection of contrast medium and to be described by the positioner in four or five cardiac cycles. The path could also be optimized to make possible a three-dimensional coronary reconstruction. The angular velocity can advantageously be synchronized with the movements of the heart, for example, by means of an electrocardiogram signal, with a rather slow velocity during the systole phase and a rather rapid velocity during the diastole phase, in order to take the movement of the heart into account. The displacement of the positioner will be calculated by the control unit 16, so that the displacements from one reference position to the following reference position may be carried out during the diastole phase, when the heart practically does not more and displacement may be slowed down in proximity to the reference position while the heart is in systole phase. In the control unit 16, a path such as illustrated in FIG. 5 or even the reference angulations from which the path is calculated can be stored in a memory. The displacement is then entirely automated, which enables the user to concentrate on other tasks.

The total duration of imaging is considerably reduced from imaging of the FIG. 3 type by reason partly of the automated displacement without the user's intervention once it is started, partly by the imaging in motion and partly because of the reduction in number of injections of contrast medium.

In relation to imaging with a view to reconstruction, of the kind illustrated in FIG. 4, the invention enables image quality to be improved by using angulations making possible a better visualization of certain coronary structures.

The fact that a displacement of the positioner of the radiology apparatus is defined by at least two rotations makes it possible not only to obtain the advantages of imaging with positioner off (FIG. 3) and the advantages of imaging in simple plane rotation (FIG. 4), but also additional advantages, such as the improvement of quality of three-dimensional reconstruction or reduction of duration of the radiological examination.

Finally, a signal emitted by an electrocardiogram 41 may advantageously be transmitted to the control unit 16 in order to make possible the synchronization of movement of the positioner and rate of imaging with the movements of the heart.

The different axes of rotation of the device are secant at a point called isocenter, through which the axis of the beam also passes.

The path can be standard, that is, memorized in a memory of the arithmetical unit when the apparatus or software is put into service, determined by the arithmetical unit from angulations indicated by a user, or also of the previous type and memorized. Displacement of the moving assembly along the path is thus automated and requires less attention by the user, resulting in reduced fatigue. The images taken make possible a three-dimensional reconstruction for a pleasing and effective display of an object situated in the energy beam between the emitter and the receiver.

Angulation is understood here as a set of n angle values making it possible to define the position of the X-ray beam in space; n is equal to 3, but can also be equal to the number of axes of rotation of the apparatus, which can be different from 3, for example, 2 or 4.

Various modifications in structure and/or steps and/or function may be made by one skilled in the art without departing from the scope of the invention.

What is claimed is:

1. A method of acquisition of images of an object in an imaging system equipped with a rotating assembly comprising an energy beam emitter and an energy beam receiver, the energy beam being centered on an axis, in which a continuous path of the rotating assembly is defined along at least two axes of a three-dimensional coordinate system, the axis of the energy beam describing a left or three-dimensional curve on the path; and, in the course of the path, the energy beam is emitted and images are acquired.

2. The method according to claim 1 wherein the path passes through or in immediate or close proximity to at least one reference position.

3. The method according to claim 1 wherein the rate of displacement of the rotating assembly is linked to its position in the three-dimensional coordinate system.

4. The method according to claim 2 wherein the rate of displacement of the rotating assembly is linked to its position in the three-dimensional coordinate system.

5. The method according to claim 1 wherein the object to be imaged is a heart of the patient's heart are acquired.

6. The method according to claim 5 wherein the rate of displacement of the rotating assembly is slow during systole and rapid during diastole.

7. The method according to claim 1 wherein the rate of displacement of the rotating assembly is slow in proximity to reference positions and rapid between two reference positions.

8. The method according to claim 2 wherein the rate of displacement of the rotating assembly is slow in proximity to reference positions and rapid between two reference positions.

9. The method according to claim 3 wherein the rate of displacement of the rotating assembly is slow in proximity to reference positions and rapid between two reference positions.

10. The method according to claim 6 wherein the rate of displacement of the rotating assembly is slow in proximity to reference positions and rapid between two reference positions.

11. The method according to claim 1 wherein the rate of image acquisition is linked to the position of the rotating assembly in the three-dimensional coordinate system.

12. The method according to claim 2 wherein the rate of image acquisition is linked to the position of the rotating assembly in the three-dimensional coordinate system.

13. The method according to claim 3 wherein the rate of image acquisition is linked to the position of the rotating assembly in the three-dimensional coordinate system.

14. The method according to claim 6 wherein the rate of image acquisition is linked to the position of the rotating assembly in the three-dimensional coordinate system.

15. The method according to claim 7 wherein the rate of image acquisition is linked to the position of the rotating assembly in the three-dimensional coordinate system.

16. The method according to claim 11 wherein the rate of image acquisition is slow in proximity to reference position and rapid between two reference positions.

17. The method according to claim 2 wherein the rate of image acquisition is slow in proximity to reference position and rapid between two reference positions.

18. The method according to claim 3 wherein the rate of image acquisition is slow in proximity to reference position and rapid between two reference positions.

19. The method according to claim 6 wherein the rate of image acquisition is slow in proximity to reference position and rapid between two reference positions.

20. The method according to claim 7 wherein the rate of image acquisition is slow in proximity to reference position and rapid between two reference positions.

21. The method according to claim 11 wherein the rate of image acquisition is slow in proximity to reference position and rapid between two reference positions.

22. The method according to claim 16 wherein the reference positions are stored in a memory.

23. The method according to claim 1 wherein the path is stored in a memory.

24. The method of claim 1 wherein the images are acquired while the assembly is rotating.

25. An image acquisition device comprising an energy beam emitter, an energy beam receiver, the energy beam being centered on an axis, the emitter and receiver being rotated about an object to be imaged, and an arithmetical unit capable of controlling the emitter and of processing data coming from the receiver, wherein the arithmetical unit comprises a means for defining a path of a rotating assembly for the emitter and receiver along at least two axes of a three-dimensional coordinate system, the axis of the energy beam describing a left or three-dimensional curve on the path, and a means for controlling the emission of the energy beam and the acquisition of images on the path.

26. The device according to claim 25 wherein the path passes through or in immediate or close proximity to at least one reference position.

27. The device according to claim 25 wherein the rate of displacement of the rotating assembly is linked to its position in the three-dimensional coordinate system.

28. The device according to claim 24 wherein the rate of displacement of the rotating assembly is slow in proximity to reference psotioins and rapid between two reference positions.

29. The device according to claim 25 wherein the rate of image acquisition is linked to the position of the rotating assembly in the three-dimensional coordinate system.

30. The device of claim 28 wherein the rate of image acquisition is slow in proximity to reference position and rapid between two reference positions.

31. The device of claim 29 wherein the reference positions are stored in a memory.

32. The device of claim 24 wherein the path is stored in a memory.

33. A method of acquiring images of an object in a system comprising a rotating assembly having means for emitting an energy beam and means for receiving the energy beam, the energy beam being emitted along an axis comprising the steps of:
(a) rotating the assembly in a continuous path or trajectory defined by at least two axes of a three-dimensional coordinate system such that the axis of the energy beam defines a three-dimensional along the path or trajectory; and
(b) acquiring the images during the traversing of the path or trajectory and while the assembly is rotating.

34. An apparatus comprising means for emitting an energy beam, means for receiving the energy beam after passing through an object, means for rotating the means for emitting and the means for receiving about the object and along at least two axes of a three-dimensional coordinate systems such that the energy beam defines a three-dimensional trajectory and means for acquiring images during the trajectory and while the means for rotating is rotating.
